(19) United States
(12) Patent Application Publication
(10) Pub. No.: US 2007/0074383 A2
(43) Pub. Date: Apr. 5, 2007

(54) Process for forming the stator of a linear motor, annular stack of lamination elements and stator for an electric motor

(75) Inventors: Orlando Starke, Joinville - SC (BR); Ingwald Vollrath, Joinville - SC (BR); Landoaldo Lindroth Junior, Joinville-SC (BR); Luiz Dokonal, Joinville - SC (BR)

Correspondence Address: DARBY & DARBY P.C., P. O. BOX 5257, NEW YORK, NY, 10150-5257, US

(73) Assignee: Empresa Brasileira De Compressores S.A. - Embraco, Joinville - SC (BR)

(21) Appl. No.: 10/519,010

(22) Filed: Feb. 24, 2005

(30) Foreign Application Priority Data
Jul. 3, 2002 (BR) PI 0203507-3

(51) Int. Cl. H02K 15/14; H02K 15/16

(52) U.S. Cl. 29/596

(57) ABSTRACT

A process for forming the stator of a linear electric motor, an annular stack of lamination elements, and a stator for an electric motor, said stator comprising an annular stack of laminations elements (5) within which is mounted a tubular coil (6), said process comprising the steps of: a-providing lamination elements (10), each being defined by two lamination portions (13, 14) to be affixed to each other to complete the respective lamination element (10); b-forming two mutually complementary annular assemblies (20, 30), with the lamination portions (13, 14) of each annular assembly (20, 30) being seated side by side in relation to each other; and c-seating in the interior of each of said annular assemblies (20, 30) a respective adjacent end portion of the tubular coil (6), affixing the two annular assemblies (20, 30) to each other, to complete the shape of the annular stack of lamination elements (5).

### FIELD OF THE INVENTION

The present invention refers to a process for forming the stator of a linear motor and, more particularly, for the assembly of its internal annular stack of metallic laminations that will carry the coil of said linear motor.

### BACKGROUND OF THE INVENTION

In the manufacture of a hermetic compressor of refrigeration with a linear motor, there are several components that form the compressor, such as the linear motor. This type of motor is formed of an annular stack of metallic laminations of the stator of the linear motor and around which is wound a copper wire, forming the induction coil of the motor.

The linear motor further presents another assembly of metallic laminations, also forming a radial stack known as external annular stack and which defines, with the stator, an annular space within which moves the magnetic impeller, whose function is to produce the linear movement of the piston of the compressor, which allows said piston to carry out the compression operation inside a cylinder of the compressor.

There are known processes which define configurations for a linear stator using entire laminations in the manufacture of the linear stators presenting an axially asymmetric topology with laminations of the “C” or “U” types, or in the form of a daisy, and which carry magnets in the movable part (U.S. Pat. No. 4,602,174, U.S. Pat. No. 4,346,318, U.S. Pat. No. 4,349,757, U.S. Pat. No. 4,454,426, U.S. Pat. No. 4,623,08). Such solutions present, regarding manufacturing aspects, several difficulties, such as: lodging the coil in the annular structure of laminations; insulating the coil from the lamination structure, according to international electrical insulation rules; fixation of the coil and/or the coil windings, which are required to be rigidly affixed, considering the high forces applied thereon, due to the high acceleration resulting from the reciprocating movement according to the frequency of the power system.

### OBJECTS OF THE INVENTION

Thus, it is an object of the present invention to provide a process for forming the stator of a linear motor, which facilitates the assembly of the stator, particularly the coil therewithin, allowing maximizing the amount of windings of the copper wire in the interior of said stator and further allowing the fixation of the metallic laminations of the formed lamination stack to present sufficient strength to resist the efforts applied to the stator during the operation of the linear motor.

Another object of the present invention is to provide a process for forming the stator, such as mentioned above, which allows the coil of said stator to be electrically insulated in an easy and adequate manner.

### SUMMARY OF THE INVENTION

These and other objectives are achieved by a process for forming the stator of a linear electric motor, said stator comprising an annular stack of lamination elements in which is mounted a tubular coil, said process comprising the steps of: a-providing lamination elements, each being defined by two lamination portions to be affixed to each other, to complete the respective lamination element; b-forming two mutually complementary annular assemblies, with the lamination portions of each annular assembly being seated side by side in relation to each other; and c-seating, in the interior of each of said annular assemblies, a respective adjacent end portion of the tubular coil, affixing two annular assemblies to each other, to complete the shape of the annular stack of lamination elements. Also, the objectives above are achieved with an annular stack comprising a plurality of lamination elements seated laterally to each other, each lamination element having an internal axial extension and two end radial extensions, and in said annular stack is mounted a tubular coil, each lamination element being defined by two lamination portions to be affixed to each other to complete the respective lamination element, at least one of said lamination portions having at least part of the internal axial extension of the respective lamination element and one of the end radial extensions.

The present invention further presents an annular stack of lamination elements of the type that forms the stator of a linear electric motor, comprising a plurality of lamination elements seated laterally to each other, each lamination element having an internal axial extension and two end radial extensions, and in said lamination stack is mounted a tubular coil, each lamination element being defined by two lamination portions affixed to each other to complete the respective lamination element.

The invention also presents a stator for an electric motor of the type comprising a stack of lamination elements of the type described above, and a tubular coil provided with an insulating cover.

The present invention presents some advantages in relation to the known conventional prior art constructions, such as: the possibility of winding the copper wire that forms the coil in conventional machines; the achievement of high amounts of windings of the copper wire of the coil; complying with the requirements of the electrical insulation of said coil, according to the international electric safety rules, with the electrical insulation being effected by a conventional process; and the reliability of the fixation of the copper windings of the coil as a whole.

### BRIEF DESCRIPTION OF THE DRAWINGS

The invention will be described below, with reference to the enclosed drawings, in which:

FIG. 1 is a longitudinal sectional view of a linear motor, showing a known stator construction of the prior art, having an annular stack of laminations formed with single piece laminations;

FIG. 2 is a lateral view of a single piece lamination of the type used in the annular stack of laminations illustrated in FIG. 1;

FIG. 3 is a lateral view of two lamination portions of an annular stack of laminations formed according to the present invention;

FIG. 4 is a perspective view of an annular alignment of a lamination portion of the lamination stack to be formed according to the present invention;

FIG. 5 is a perspective view of a reel for the formation of the coil, being mounted before placing it in the stator of the present invention;

FIG. 6 is a perspective view of the reel for the formation of the coil, electrically insulated and provided with contact terminals, before placing it in the stator of the present invention;

FIG. 7 is a perspective view of the coil mounted to an annular alignment of one of the lamination portions for the formation of the stack of laminations of the present invention; and

FIG. 8 is a perspective view of the coil mounted between two annular alignments of lamination portions for the formation of the lamination stack of the present invention;

### DESCRIPTION OF THE ILLUSTRATED EMBODIMENT

The present invention is applied to the formation of the stator of a linear electric motor, which is generally used in a hermetic compressor of refrigeration systems, said compressor comprising, inside a shell (not illustrated): a motor-compressor assembly including a non-resonant assembly formed by a linear motor and a cylinder 1, and a resonant assembly formed by a piston 2 reciprocating inside the cylinder 1, and an actuating means 3, external to the cylinder 1 and which carries a magnet 4 axially impelled upon energization of the linear motor, said actuating means 3 operatively coupling the piston 2 to the linear motor.

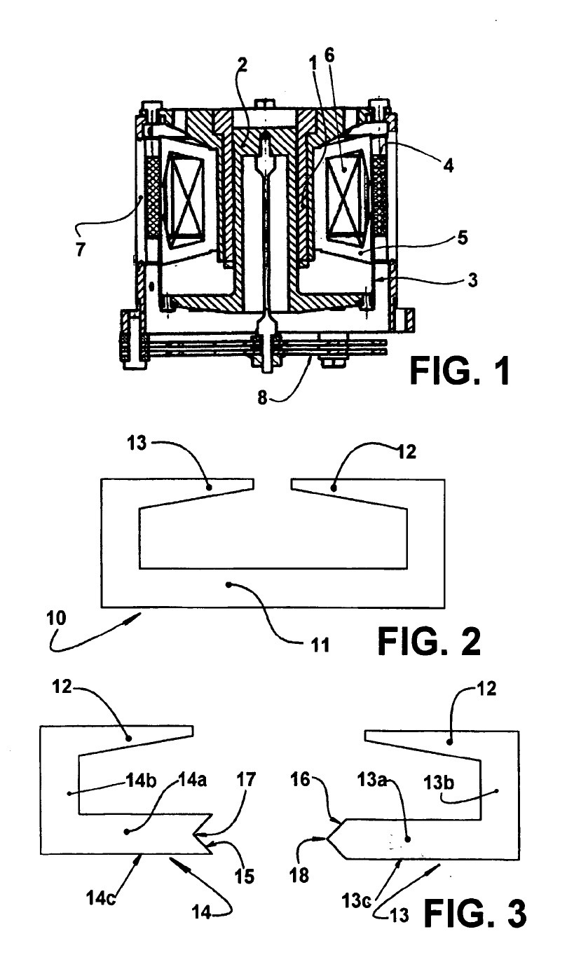

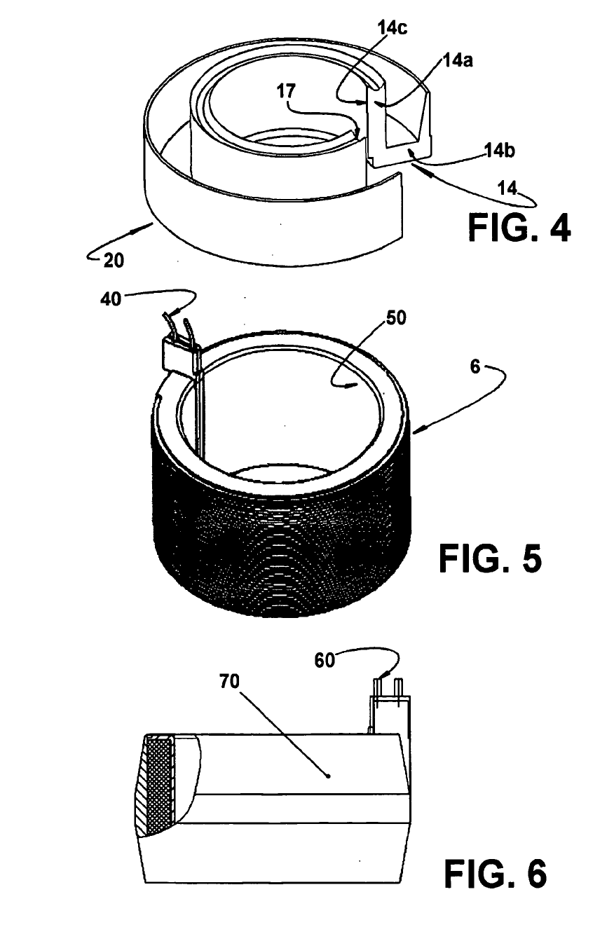

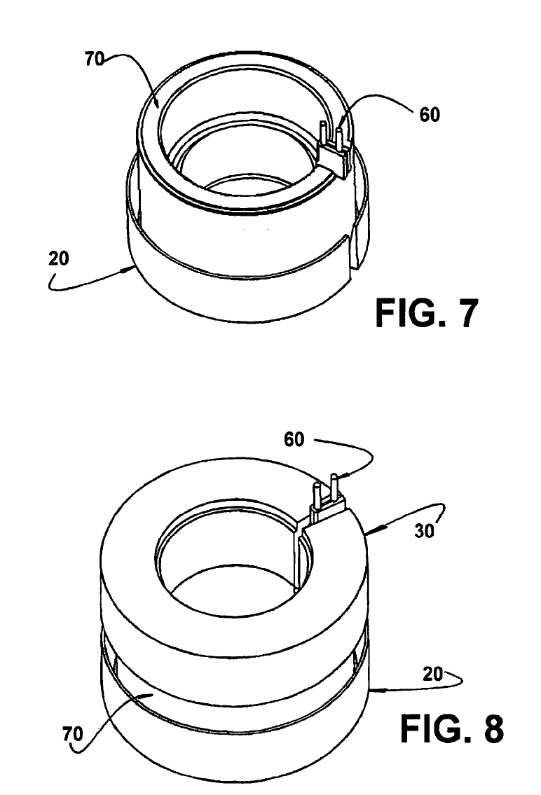

As illustrated in the enclosed FIG. 1, the linear motor is mounted around the cylinder 1 and the piston 2, and comprises therewithin an annular stack 5, which is formed by a plurality of metallic lamination elements 10 laterally seated in relation to each other, and in which annular stack 5 is mounted a tubular coil 6 and an external annular stack 7 formed by a plurality of external metallic laminations.

The internal and external annular stacks are each formed by the mutual lateral seating of the metallic laminations, generally made of steel, and which form said stack, defining a cylindrical internal surface for mounting, for example the internal annular stack 5, around the cylinder 1.

The external annular stack 7 forms with the stator an annular space, inside which moves the actuating means 3, whose function is to produce the linear movement of the piston 2 inside the cylinder 1.

The compressor also includes conventional resonant spring means 8, which are mounted constantly compressing the resonant assembly and the non-resonant assembly and which are resiliently and axially deformed toward the displacement direction of the piston 2.

Each lamination element 10 presents an internal axial extension 11 and two radial end extensions 12 defining, as illustrated, a trapezoidal profile for the lamination element 10, with the smallest base coinciding with the internal axial extension 11.

According to the present invention, each lamination element 10 is defined by two lamination portions 13, 14, at least one of them having at least part of the internal axial extension 11 of the respective lamination element 10, said lamination portions 13, 14 being affixed to each other during the formation of the stator to complete the respective lamination element 10, as described below.

According to a constructive form as illustrated, each lamination element 10 presents a respective lamination portion 13, 14 having its respective internal axial extension 13a, 14a carrying a corresponding radial extension 13b, 14b.

For the fixation of the lamination portions to each other, in order to form each lamination element 10, said lamination portions are seated to each other through a respective seating region 15, 16, for example by fitting said seating regions 15, 16 to each other, one of which presenting a recess 17 to be fitted in a complementary projection 18 provided in the other seating region 15, 16 upon the assembly of the annular stack of lamination elements 5, as described below.

According to the present invention, each lamination portion 13, 14 presents a respective radially internal edge 13c, 14c to be mutually laterally seated side by side with a radially internal edge 13c, 14c of an adjacent lamination portion 13, 14 defining a rectilinear alignment of each plurality of lamination portions 13, 14.

After the rectilinear alignment of each plurality of lamination portions 13, 14, the latter are affixed to each other, so as to allow only the related limited angular displacement of each said lamination portion 13 14 to occur around a rotation shaft coinciding with the respective radially internal edge 13c, 14c.

After the fixation of the lamination portions 13, 14 in a rectilinear alignment, the latter are conducted to a step of deforming said alignment to an annular configuration, until an end lamination portion 13, 14 of each respective alignment of a plurality of lamination portions 13, 14, is seated against another opposite end lamination portion 13, 14, of said plurality of laminations. This deformation makes the radially internal edges 13c, 14c to define an internal cylindrical surface for the respective annular assembly 20, 30, said annular assemblies 20, 30 being complementary to each other in the formation of the annular stack of lamination elements 5. The internal cylindrical surface of each annular assembly is defined so as to present a previously calculated diameter for the annular stack of lamination elements 5 to be formed, as a function of the dimensioning of the region for the mounting of said stack in the electric motor.

According to the present invention, after forming each annular assembly 20, 30, each of the latter receives a respective end portion of the tubular coil 6, to allow the complementary seating regions 15, 16 to be seated and affixed to each other, completing the form of the annular stack of lamination elements 5.

In the embodiment of the present invention illustrated in FIG. 8, an end portion of the tubular coil 6 is first seated in the interior of one of the annular assemblies 20, 30, before mounting it to the other end portion of said tubular coil 6 of the other annular assembly 20, 30. In another embodiment, each annular assembly 20, 30 is simultaneously seated to an adjacent end portion of the tubular coil 6.

According to one way of carrying out the present invention, the fixation of the two annular assemblies 20, 30 to each other for the formation of the annular stack of lamination elements 5 is effected by providing an adhesive bead (not illustrated) in the seating region 15, 16 of at least one of the pluralities of lamination portions 13, 14 that form each annular assembly 20, 30, said adhesive being cured under tension, for example.

As a function of the construction of the stator of the present invention, the tubular coil 6 can be obtained prior to placing it inside the annular stack of lamination elements S, by winding each copper wire 40 in a reel 50, made of plastic, for example (FIG. 5) and which presents means to provide the insulation of the ends of the wire that forms the coil. At the end of the wire winding operation, the connection of said ends to conducts 60 is effected, for example by welding and said conducts operate, for example to connect the tubular coil 6 to a power supply cable, not illustrated. In the present construction, the assembly defined by the wound copper wire 40 and the reel 50 receives an insulating cover 70, for example made of injected plastic material (FIG. 6), to guarantee the complete insulation of the coil from the ferromagnetic structure of the electric motor. The assembly formed by the wound copper wire 40, reel 50, and insulating cover 70 defines the tubular coil 6 that will be placed and affixed, for example by an adhesive, between the annular assemblies 20, 30 (FIG. 8).

1. A process for forming the stator of a linear electric motor, said stator comprising an annular stack of lamination elements (5) seated laterally to each other, each lamination element (5) having an internal axial extension (11) and two end radial extensions (12), and in which annular stack is mounted a tubular coil (6), characterized in that it comprises the steps of:
a-providing lamination elements (10), each defined by two lamination portions (13, 14) to be affixed to each other to complete the respective lamination element (10), at least one of said lamination portions (13, 14) having at least part of the internal axial extension (11) of the respective lamination element (10);
b-providing a rectilinear alignment of each of a plurality of lamination portions (13, 14) presenting a radially internal axial edge (13c, 14c), said lamination portions (13, 14) being laterally mutually seated, with their respective radially internal axial edges (13c, 14c) defining a flat surface;
c-affixing to each other the radially internal axial edges (13c, 14c) of the lamination portions (13, 14) of he rectilinear alignment of each plurality of lamination portions (13, 14), to allow only the relative limited angular displacement of each lamination portion (13, 14) around its part of the radially internal axial edge (13c, 14c);
d-deforming the alignment of each plurality of lamination portions (13, 14) affixed to each other to an annular shape, with the respective radially internal axial edges (13c, 14c) defining an internal cylindrical surface of the respective annular assembly (20, 30);
e-forming two mutually complementary annular assemblies (20, 30), with the lamination portions (13, 14) of each annular assembly (20, 30) being seated side by side in relation to each other; and
f-seating in the interior of each of said annular assemblies (20, 30) a respective adjacent end portion of the tubular coil (6), affixing the two annular assemblies. (20, 30) to each other to complete the shape of the annular stack of lamination elements (5).

2. The process according to claim 1, characterized in that in step “f” the two annular assemblies (20, 30) of lamination elements (10) are affixed to each other in seating regions (15, 16) with mutual fitting.

3. The process according to claim 1, characterized in that the mutual fixation of the lamination portions (13, 14) is obtained with the step of providing an adhesive to the seating region (15, 16) with the mutual fitting of at least one of the annular assemblies (20, 30).

4. The process according to claim 3, characterized in that it comprises the further step of submitting the adhesive to cure under tension, mutually affixing the lamination portions (13, 14) of the two annular assemblies (20, 30).

5. The process according to claim 3, characterized in that, in step “a”, one of the lamination portions (13, 14) of each lamination element (10) is provided with a recess (17) in the seating region (15, 16) for the other lamination portion (13, 14), which is provided in the respective seating region (15, 16) with a complementary projection (18) to be fitted in said recess (17) upon the fixation of the two annular assemblies (20, 30).

6. The process according to claim 1, characterized in that step “f” comprises the additional steps of:
seating a respective end portion of the tubular coil (6) in the interior of one of said annular assemblies (20, 30); and
mounting the other of said annular assemblies (20, 30) to the remainder of the tubular coil (6), affixing the two annular assemblies (20, 30) to each other, to complete the shape of the annular stack of lamination elements (5).

7. The process according to claim 1, characterized in that it includes a further step of providing the tubular coil (6) with an insulating cover (70).

8. The process according to claim 7, characterized in that the insulating cover (70) is injected around the tubular coil (6).

9. The process according to claim 1, characterized in that the tubular coil (6) is affixed between the annular assemblies (20, 30).

10. The process according to claim 9, characterized in that the tubular coil (6) is affixed by adhesive to the annular assemblies (20, 30).

11. An annular stack of lamination elements of the type for forming the stator of a linear electric motor and comprising a plurality of lamination elements (10) seated laterally to each other, each lamination element (10) having an internal axial extension (11) and two end radial extensions (12), and in which annular stack is mounted a tubular coil (6), characterized in that each lamination element (10) is defined by two lamination portions (13, 14) to be affixed to each other, to complete the respective lamination element (10), at least one of said lamination portions (13, 14) having at least part of the internal axial extension (11) of the respective lamination element and one of the end radial extensions (12).

12. The lamination stack according to claim 8, characterized in that each lamination portion (13, 14) presents a respective seating region (15, 16) for the mutual fitting to the other lamination portion (13, 14) upon the fixation of two annular assemblies (20, 30) to each other.

13. The lamination stack according to claim 9, characterized in that one of the lamination portions (13, 14) of each lamination element (10) presents a recess (17) in the respective seating region (13c, 14c) for the fitting of a complementary projection (18) provided in another lamination portion (13, 14), to complete the respective lamination element (10) upon the fixation of two annular assemblies (20, 30) to each other.

14. A stator for an electric motor of the type comprising a plurality of lamination elements (10) seated laterally to each other, each lamination element (10) having an internal axial extension (11) and two end radial extensions (12), in which stator is mounted a tubular coil (6), characterized in that each lamination element (10) is defined by two lamination portions (13, 14) to be affixed to each other, to complete the respective lamination element (10), at least one of said lamination portions (13, 14) having at least part of the internal axial extension (11) of the respective lamination element (10) and one of the end radial extensions (12), and the tubular coil (6) being provided with an insulating cover (70) injected thereon.
